(19) United States
(12) Patent Application Publication
(10) Pub. No.: US 2026/0168112 A1
(43) Pub. Date: Jun. 18, 2026

(54) SYSTEMS AND METHODS FOR FLUORIDE-ION CLEANING OF GAS TURBINE COMPONENTS

(71) Applicant: GE Infrastructure Technology LLC, Greenville, SC (US)

(72) Inventors: Jonathan Lomas, Simpsonville, SC (US); James C. Dalton, Marietta, SC (US); Shan Liu, Central, SC (US); Jesse Keller, Greenville, SC (US); Mark L. Hunt, Greenville, SC (US); Stanley F. Simpson, Greenville, SC (US)

(21) Appl. No.: 18/980,444

(22) Filed: Dec. 13, 2024

(51) Int. Cl. C23G 5/028; F01D 25/00

(52) U.S. Cl. CPC C23G 5/02803; F01D 25/002

(57) ABSTRACT

A system for fluoride-ion cleaning processes includes at least one test device configured to be received within an interior volume of a reaction chamber. A test volume is defined by each of the at least one test device. Each of the at least one test device defines a metering inlet through which reaction gas from the interior volume of the reaction chamber is received in the test volume. Additionally, the system includes at least one test sample, each of the at least one test sample being configured to be received within the test volume of a respective one of the at least one test device and cleaned by the reaction gas received within the test volume through the metering inlet.

### FIELD

The present disclosure relates generally to repair operations on gas turbine components and, more specifically, to systems and methods for improved fluoride ion cleaning of gas turbine components.

### BACKGROUND

Aeronautical and power generation turbine components, such as blades, shrouds, and vanes, are often formed from superalloy materials, including but not limited to, nickel-, cobalt-, and iron-nickel-based superalloy materials. During service, turbine components are exposed to high pressure and high temperature environments and may form complex, chemically stable, thermal oxides. These oxides include, but are not limited to, oxides of aluminum, titanium, chromium, and combinations thereof. Turbines are periodically overhauled in order to prolong service life or enhance performance. During these overhauls, the turbine components may be subjected to various repair operations, including welding or brazing. The presence of chemically stable thermal oxides reduces the ability of a superalloy to be welded or brazed. Therefore, removal of these oxides by cleaning the turbine components prior to repair is important for successful completion of the overhaul.

At least some known high-temperature, reactive-atmosphere batch cleaning processes affect cleaning of chemically stable oxides from turbine components. The processes that generally rely on the high reactivity of fluoride ions for cleaning are collectively known as “fluoride ion cleaning” (FIC) processes. Current embodiments of FIC processes include single volume chambers, or single volume chambers with distribution manifolds, designed to provide uniform heating and working fluid distribution and exchange. At least some known embodiments of FIC processing, such as a dynamic FIC process, enable working fluids to flow during operation. Other known FIC processes, such as pulsed FIC processes, operate between alternating pressure and flow conditions to facilitate improving the effectiveness of the cleaning cycles. In addition, at least some known FIC processes operate with an increased flow rate of hydrogen fluoride (HF) to facilitate cleaning more tenacious oxides.

When used components (e.g., gas turbine components) have cracks to be repaired, the oxidation within the cracks needs to be removed before the parts may be properly repaired. However, it is difficult to determine how well FIC processes have actually cleaned the oxidation within the cracks, particularly at the deepest parts of the cracks within the parts.

Accordingly, systems and methods for fluoride-ion cleaning of gas turbine components that help identify the effectiveness of the FIC process would be useful.

### BRIEF DESCRIPTION

Aspects and advantages of systems and methods in accordance with the present disclosure will be set forth in part in the following description, or may be obvious from the description, or may be learned through practice of the technology.

In accordance with aspects of the present subject matter, a system for fluoride-ion cleaning (FIC) processes is provided. The system may include a reaction chamber defining an interior volume, an inlet for providing reaction gas to the interior volume, and an outlet for exhausting the reaction gas from the interior volume. The system may further include a reaction gas source coupled to the inlet, with the reaction gas source configured to selectively provide the reaction gas to the inlet. Moreover, the system may include at least one test device configured to be received within the interior volume of the reaction chamber. A test volume being defined by each of the at least one test device, and each of the at least one test device defining a metering inlet through which the reaction gas from the interior volume of the reaction chamber is received in the test volume. Additionally, the system may include at least one test sample, each of the at least one test sample being configured to be received within the test volume of a respective one of the at least one test device and cleaned by the reaction gas received within the test volume through the metering inlet.

In accordance with further aspects of the present subject matter, a test device for a fluoride-ion cleaning (FIC) process is provided, with the test device being configured to be received within a reaction chamber for the FIC process. The test device may include a base and a cover detachably couplable to the base to define a test volume between the cover and the base for receiving a test sample to be cleaned. The cover may have a sidewall extending between a first end and a second end, an upper surface at the first end, and a lower surface at the second end. The cover may define a recess extending from the lower surface towards the upper surface, with the cover defining a metering inlet extending through the cover to the recess, and with the test volume being at least partially defined by the recess. Reaction gas may be received in the test volume through the metering inlet from the reaction chamber. At least one dimension of the metering inlet may correspond to at least one respective dimension of a crack in a service part to be cleaned within the reaction chamber.

In accordance with additional aspects of the present subject matter, a method for performing a fluoride-ion cleaning (FIC) process is provided. The method may include supporting a test sample to be cleaned on a base of a test device. The method may further include coupling a cover of the test device to the base such that the test sample is received within a test volume defined between the base and the cover, where the test device defines a metering inlet through which reaction gas from a reaction chamber is receivable in the test volume. Further, the method may include placing, after coupling the cover of the test device to the base, the test device within an interior volume of the reaction chamber, where the reaction chamber defines an inlet for providing the reaction gas to the interior volume, and where the reaction chamber defines an outlet for exhausting the reaction gas from the interior volume. The method may further include controlling a reaction gas source to provide the reaction gas to the inlet of the reaction chamber for performing a FIC process. Moreover, the method may include removing the test sample from the test volume after performing the FIC process. Additionally, the method may include determining an efficacy of the FIC process for cleaning a crack in a service part based at least in part on evaluation of the test sample after performing the FIC process.

These and other features, aspects and advantages of the present systems and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present systems and methods, including the best mode of making and using the present systems and methods, directed to one of ordinary skill in the art, is set forth in the specification, which makes reference to the appended figures.

FIG. 1 illustrates a device for use with an example fluoride ion cleaning system in accordance with aspects of the present subject matter;

FIG. 2 illustrates the device of FIG. 1 with a further example of a fluoride ion cleaning system in accordance with aspects of the present subject matter;

FIG. 3 illustrates a perspective view of the device shown in FIGS. 1 and 2 in an assembled configuration in accordance with aspects of the present subject matter;

FIG. 4 illustrates a perspective view of the device shown in FIGS. 1-3 in a partially disassembled configuration in accordance with aspects of the present subject matter;

FIG. 5 illustrates a sectional view of the device shown in FIGS. 1-4 taken with reference to section line 5-5′ in FIG. 3 in accordance with aspects of the present subject matter;

FIG. 6 illustrates a perspective view of another configuration of a device suitable for use with the fluoride ion cleaning systems shown in FIGS. 1 and 2 in accordance with aspects of the present subject matter;

FIG. 7 illustrates another example of a fluoride ion cleaning system in accordance with aspects of the present subject matter; and

FIG. 8 illustrates a flowchart diagram of an exemplary method for performing a fluoride-ion cleaning (FIC) process in accordance with aspects of the present subject matter.

Repeat use of reference characters in the present specification and drawings is intended to represent the same and/or analogous features or elements of the present invention.

### DETAILED DESCRIPTION

Reference now will be made in detail to embodiments of the present systems and methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the technology. As used herein, the terms “first,” “second,” and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Each example is provided by way of explanation of the technology, not limitation of the technology. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents. Although exemplary embodiments will be described generally in the context of fluoride-ion cleaning of components of a power-generating gas turbine for purposes of illustration, one of ordinary skill in the art will readily appreciate that embodiments of the present technology may be applied to similar cleaning with any other suitable gases, and/or fluoride-ion cleaning of any components for any type of turbomachine and/or for any other suitable components and are not limited to power-generating gas turbines unless specifically recited in the claims.

The embodiments described herein relate to systems and methods for improved fluoride ion cleaning of gas turbine components, for example. A fluoride ion cleaning (FIC) process, as disclosed herein, includes a hydrogen-enhanced, mixed-gas FIC process (hereinafter referred to as “H-FIC”), which removes oxides from surfaces and cracks of articles. The H-FIC process can be used to clean metal articles, such as but not limited to superalloy aeronautical and power generation turbine vanes, shrouds, blades, and like elements (hereinafter “turbine components”).

In general, as described above, during operation, turbine components are exposed to high pressure and high temperature environments and may form complex, chemically stable, thermal oxides. During maintenance, the turbine components may be subjected to various repair operations, including welding or brazing. The presence of chemically stable thermal oxides reduces the ability of a superalloy to be welded or brazed. Therefore, removal of these oxides by cleaning the turbine components, such as with FIC processes, prior to repair is important for successful completion of the overhaul. However, it is difficult to determine how effective FIC processes remove oxide within cracks of the service parts.

As such, in accordance with aspects of the present subject matter, a test device is configured to be placed within a reaction chamber of a retort of a FIC system. A test volume for receiving a test sample is defined by the test device. A metering inlet is defined in the test device through which reaction gas (e.g., hydrogen, fluoride, mixtures thereof, and/or the like) is providable to the test volume from the reaction chamber. The metering inlet is configured to mimic a crack in the turbine component to be cleaned, and the test sample may be of a similar material and oxidation as the turbine component to be cleaned. As such, the cleaning of the test sample within the test device may indicate how well reaction gases may flow into the crack in the turbine component to be cleaned.

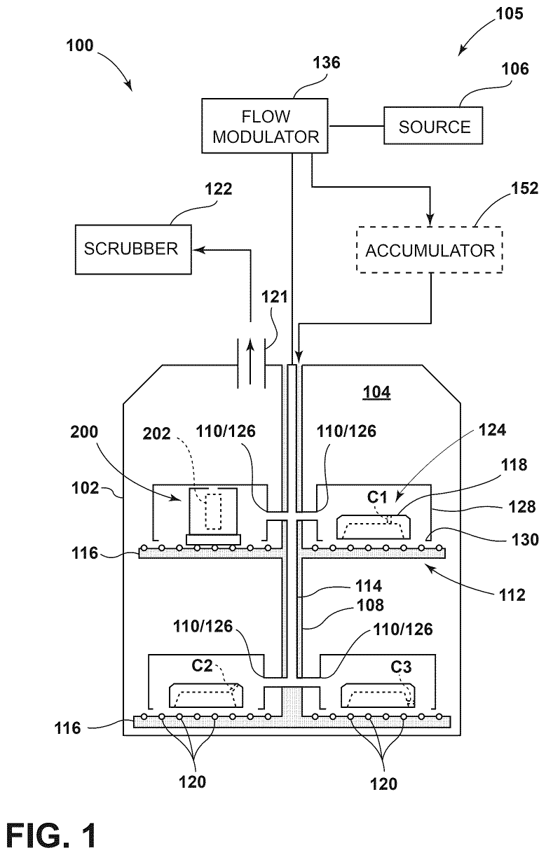

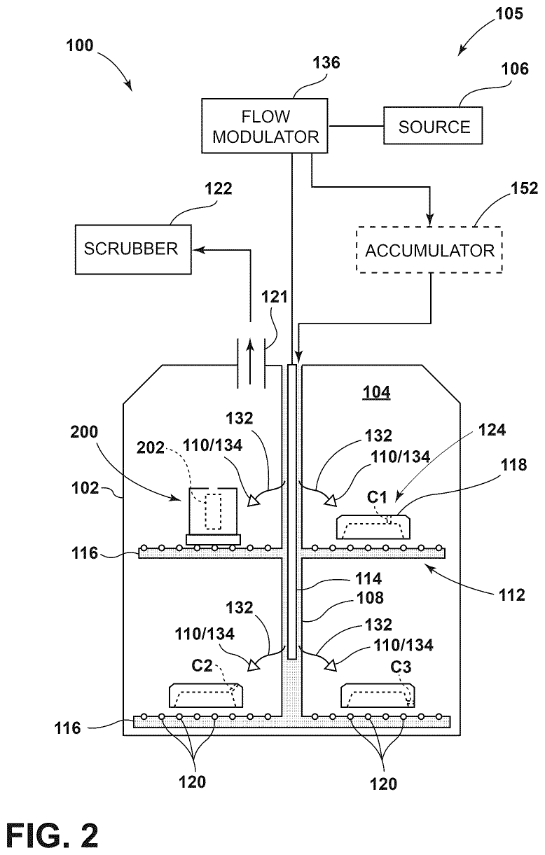

Referring now to the drawings, FIGS. 1 and 2 provide example FIC systems 100, 100′ with which the disclosed test device 200 is suitable for use.

In particular, FIG. 1 is a schematic illustration of an exemplary FIC system 100, such as a H-FIC system. However, it should be appreciated that other FIC system constructions are within the scope of the disclosure. FIC system 100 includes a reaction chamber 102 (also known as a “retort”) defining an interior volume 104 sized to receive at least one component 118 for cleaning. The reaction chamber 102 is formed from materials that are compatible with the FIC atmosphere. For example, the reaction chamber 102 may be formed from, but is not limited to being formed from, nickel-, iron-, or cobalt-based alloys.

A gas distribution system 105 of FIC system 100 includes a reaction gas source 106, a manifold 108, and at least one nozzle 110. Reaction gas source 106 supplies interior volume 104 with reaction gas via manifold 108. For example, manifold 108 includes a support rack assembly 112 disposed within interior volume 104 of reaction chamber 102. Support rack assembly 112 includes a supply conduit 114 and one or more platforms 116. Platforms 116 may be adapted to support at least one component 118 to be cleaned. In some instances, platforms 116 may be defined by grates and/or may define perforations that enable the reaction gas to pass therethrough and contact component 118. For example, manifold 108 may be configured to provide reaction gas through an inlet of the supply conduit 114 and distributed from a plurality of apertures 120 defined within the platforms 116 to the interior volume 104. Supply conduit 114 may also provide flow communication between source 106 and nozzles 110 defined separately of the platforms 116. Reaction gas is dischargeable from the reaction chamber 102 through an outlet 121. Optionally, the reaction gas discharged from the reaction chamber 102 is channeled to a scrubber 122 for separating impurities removed from the parts cleaned within the reaction chamber 102.

Any number of nozzles 110 may be included within interior volume 104 that enables FIC system 100 to function as described herein. For example, at least one nozzle 110 may be associated with a respective component 118 that is positioned within interior volume 104. The number of nozzles 110 positioned relative to, and associated with, a respective component 118 may be based on the size or quantity of target areas 124 defined thereon. In one embodiment, at least one target area 124 is a damaged area, although FIC system 100 is not limited to only being used with damaged areas of a component 118. For example, more than one nozzle 110 may be positioned relative to a respective component 118 to enhance the cleaning capabilities of FIC system 100.

As illustrated in FIG. 1, each nozzle 110 is partially defined by an opening 126 in a housing 128 that at least partially encloses a respective component 118 and that is coupled proximate the opening 126 to supply conduit 114. Housing 128 at least partially encloses component 118 to define a localized volume of reaction gas, which may be more susceptible to variations in pressure (i.e., pulses) to be generated that facilitate enhancing the cleaning of component 118. In one example, housing 128 also includes openings 130 that enable reaction gas discharged from manifold 108 (e.g., from platforms 116) to enter housing 128. Accordingly, component 118 may be oriented within housing 128 to position target areas 124 in closer proximity to a respective nozzle 110 than to undamaged areas thereof.

As illustrated in FIG. 2, one or more of nozzles 110 are alternatively defined by a flexible tube 132 that is in flow communication with supply conduit 114, and a nozzle head 134 coupled to flexible tube 132. Flexible tube 132 is fabricated from material that enables nozzle head 134 to be positioned and held in generally any orientation relative to component 118. Accordingly, nozzle 110 is movable relative to manifold 108 within interior volume 104 to position nozzle head 134 in closer proximity to target areas 124 of component 118 than to undamaged areas thereof.

A flow modulator 136 may be coupled in flow communication between reaction chamber 102 and source 106 of reaction gas. In one embodiment, flow modulator 136 can be configured or sized and shaped for insertion within reaction chamber 102. Flow modulator 136 may be controllable to vary the flow of reaction gas from reaction gas source 106 to housing 128 to vary a pressure for performing the FIC process. Flow modulator 136 may be controlled to define a pulse rate of the reaction gas that is either discharged from, or selectively extracted by, nozzles 110. For example, the pulse rate may be within a range defined between about 10 pulses/minute to about 240 pulses/minute. In one embodiment, a Pfeifenton resonator is used and/or any other type of “whistle” type of resonator that enables system 100 to work, including, but not limited to a “coaches or Pea whistle” type of resonator, or a corrugated tubing type of resonator. In such an embodiment, using a whistle type resonator, hyperdynamic pulsations may be employed with a pulse rate of between about 30 Hertz (Hz) to about 300 Hz. However, any other suitable type of resonator may instead, or additionally, be employed. Thus, the pulse rate defines an agitated flow of reaction gas that facilitates enhancing the cleaning efficiency of FIC system 100. As used herein, the term agitate as applied to the flow of reaction gases is used to describe a flow modulator 136 that has at least one flow circuit that has a faster dynamic flow response as compared to that of the reaction chamber 102 itself.

Gas distribution system 105 may include any number of flow modulators 136 that enables FIC system 100 to function as described herein. For example, a single flow modulator 136 may be fluidly coupled to multiple nozzles 110 and/or platforms 116 to define a substantially similar rate of pulsation at the multiple nozzles 110. Alternatively, different flow modulators 136 may be fluidly coupled to respective nozzles 110 and/or respective platforms 116 to define different rates of pulsation at each respective nozzle 110. Additionally, in some embodiments, FIC system 100 may include a response accumulator 152 (shown in FIGS. 1 and 2) between flow modulator 136 and one or more of the gas outlets within the interior volume 104 (e.g., nozzles 110 and/or platforms 116), where accumulator 152 may selectively change the response time of the gas outlets of the gas distribution manifold 105 relative to each other.

In at least some embodiments, FIC system 100 may further include or be in operative communication with a processing device or a controller (not shown) that may be generally configured to facilitate operation of the system 100 for a FIC process. In this regard, the controller may be in communication with various user input devices, sensors, and other control elements of the system 100 (e.g., source 106, flow modulator 136, scrubber 122, accumulator 152, and/or the like), such that the controller may receive control inputs from the user input devices and may otherwise regulate operation of system 100. For example, signals generated by the controller may operate system 100, including any or all system components, subsystems, or interconnected devices, in response to the position of user input devices and other control commands. The user input devices, sensors, and other components of system 100 may be in communication with the controller via, for example, one or more signal lines or shared communication buses. In this manner, Input/Output (“I/O”) signals may be routed between the controller and various operational components of system 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate turbomachine operation. Alternatively, the controller may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

The controller may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, the controller may be operable to execute programming instructions or micro-control code associated with an operating cycle of system 100. In this regard, the instructions may be software or any set of instructions that when executed by the processing device, cause the processing device to perform operations, such as running one or more software applications, displaying a user interface, receiving user input, processing user input, etc. Moreover, it should be noted that the controller as disclosed herein is capable of and may be operable to perform any methods, method steps, or portions of methods as disclosed herein. For example, in some embodiments, methods disclosed herein may be embodied in programming instructions stored in the memory and executed by the controller.

The memory devices may also store data that can be retrieved, manipulated, created, or stored by the one or more processors or portions of the controller. The data can include, for instance, data to facilitate performance of methods described herein. The data can be stored locally (e.g., on the controller) in one or more databases and/or may be split up so that the data is stored in multiple locations. In addition, or alternatively, the one or more database(s) can be connected to the controller through any suitable network(s), such as through a high bandwidth local area network (LAN) or wide area network (WAN). In this regard, for example, the controller may further include a communication module or interface that may be used to communicate with one or more other component(s) of system 100, the controller, an external controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As will be described below in greater detail, one or more of components 118 may have one or more cracks (e.g., cracks C1, C2, C3) extending at least part of the way through a wall thickness of the component(s) 118. However, it may be difficult to determine the efficacy of the FIC process for cleaning the cracks. As such, in accordance with aspects of the present subject matter, a test device 200 is provided for use within the FIC system 100. Test device 200 is configured to define a test volume for receiving a test sample 202 to be cleaned with the FIC process. More particularly, test device 200 defines a metering inlet through which reaction gases may be passed from interior volume 104 of reaction chamber 102 (e.g., after exiting nozzles 110 and/or apertures 120) into the test volume, where the metering inlet is configured to act similar to a crack in a turbine component (e.g., crack C1, C2, C3 in respective components 118) configured to be cleaned, or simultaneously cleaned, with the FIC process. Based on the cleaning of test sample 202, the efficacy of the FIC process for cleaning the crack in the turbine component may be determined.

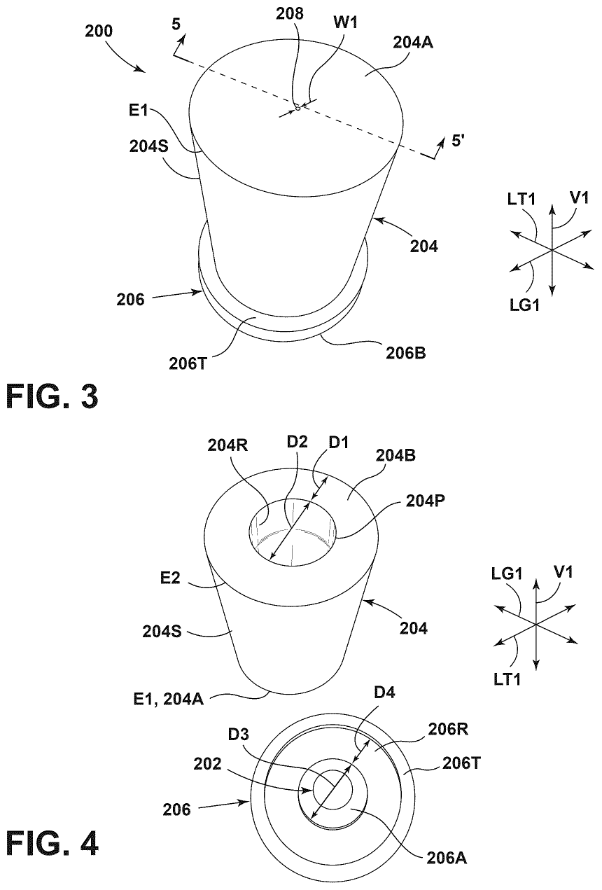

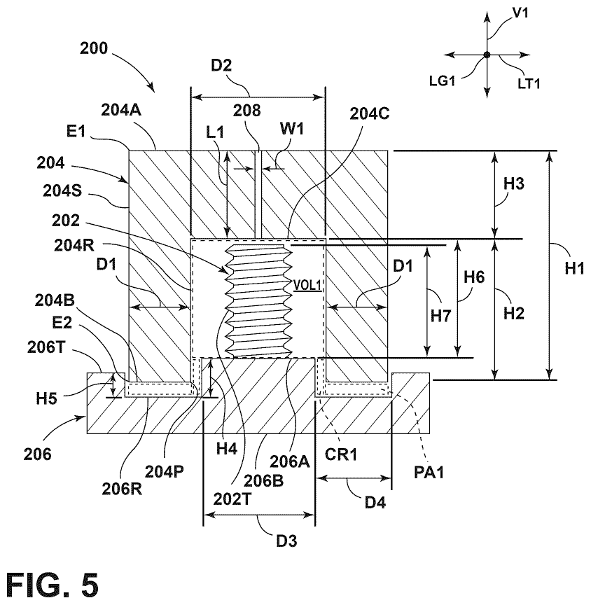

Referring now to FIGS. 3-5, different views of test device 200 are shown in greater detail. For instance, FIG. 3 illustrates a perspective view of test device 200 shown in FIGS. 1 and 2 in an assembled configuration, FIG. 4 illustrates a perspective view of test device 200 shown in FIGS. 1-3 in a partially disassembled configuration, and FIG. 5 illustrates a sectional view of test device 200 shown in FIGS. 1-4 taken with reference to section line 5-5′ in FIG. 3.

As shown, test device 200 includes a cover 204 and a base 206. Cover 204 has a sidewall 204S extending along a first height H1 (FIG. 5) in a vertical direction V1, with first height H1 being defined between a first end E1 and a second end E2 (FIGS. 4-5). Cover 204 further defines an upper cover surface 204A at first end E1 and a lower cover surface 204B (FIGS. 4-5) at second end E2. Cover 204 further defines a recess 204R (FIGS. 4-5) extending from lower surface 204B towards upper surface 204A. For instance, recess 204R is at least partially defined by an opening 204P within the lower surface 204B, with opening 204P being spaced apart from sidewall 204S in a lateral direction LT1 by a first distance D1 such that opening 204P extends across a second distance D2 (e.g., diameter) in lateral direction LT1. Recess 204R is centered in lateral direction LT1 within lower surface 204B, with distance D1 being constant around a perimeter of recess 204R. However, in some instances, recess 204R may be offset from center in lateral direction LT1 within lower surface 204B such that distance D1 varies around perimeter of recess 204R. As best shown in FIG. 5, recess 204R extends along vertical direction V1 from opening 204P in lower surface 204B to an interior recessed surface 204C, with interior recessed surface 204C being spaced apart from lower surface 204B by a second height H2. In general, second height H2 is less than first height H1. Additionally, upper surface 204A of cover 204 has a thickness defined across a third height H3 in vertical direction V1 from interior recessed surface 204C. In some instances, interior recessed surface 204C extends across the same distance in lateral direction LT1 (e.g., distance D3) as opening 204P. However, in some instances, interior recessed surface 204C extends across a different distance in lateral direction LT1 from opening 204P.

Base 206 extends between a sample support surface 206A and a bottom surface 206B along vertical direction V1. Base 206 is configured to support the test sample 202. For instance, test sample 202 may be supported on sample support surface 206A. Moreover, cover 204 may be supported on the base 206. For instance, in some instances, base 206 may include a cover support surface 206R spaced apart in vertical direction V1 from sample support surface 206A by a fourth height H4, with lower surface 204B of cover 204 being configured to rest on cover support surface 206R. Cover support surface 206R generally extends laterally outwardly in lateral direction LT1 from sample support surface 206A of base 206.

In some instances, fourth height H4 is configured such that cover support surface 206R is positioned lower than sample support surface 206A along vertical direction V1. In such instances, sample support surface 206A of base 206 is sized to be received within recess 204R of cover 204 when cover 204 rests on base 206. For instance, sample support surface 206A may extend across a third distance D3 in lateral direction LT1, with third distance D3 generally corresponding to (e.g., being equal to or less than) second distance D2. However, it should be appreciated that base 206 may be configured in any other suitable way. For example, in some instances, fourth height H4 is configured such that cover support surface 206R is positioned higher than sample support surface 206A along vertical direction V1. In one or more instances, cover support surface 206R may be even with, or form part of, sample support surface 206A.

Moreover, in some instances, cover support surface 206R forms part of a recessed area within base 206. For example, base 206 may include a top surface 206T that generally extends laterally outwardly in lateral direction LT1 from cover support surface 206R of base 206. Top surface 206T is spaced apart in vertical direction V1 by a fifth height H5 from cover support surface 206R. Particularly, fifth height H5 is configured such that cover support surface 206R is positioned lower than top surface 206T in vertical direction V1. In some instances, fourth and fifth heights H4, H5 are substantially equal. However, in one or more instances, fourth and fifth heights H4, H5 may be different. For instance, fourth height H4 may be taller than fifth height H5 in vertical direction V1. A lateral width D4 of cover support surface 206R in lateral direction LT1 defined between the sample support surface 206A and top surface 206T may generally correspond to (e.g., be substantially equal to or greater than) distance D1 such that the cover 204 may be at least partially received within the recessed area of base 206.

In some instances, upper, lower, and interior recessed surfaces 204A, 204B, 204C of cover 204 are planar and extend substantially in a plane defined by lateral direction LT1, perpendicular to vertical direction V1. However, such surface(s) 204A, 204B, 204C of cover 204 may extend in any other suitable plane(s) and/or have any other suitable shape (e.g., domed, pyramidal, etc.). In general, cover 204 and base 206 are correspondingly shaped such that base 206 is configured to receive cover 204. In some instances, sidewall 204S and recess 204R of cover 204 are substantially cylindrical with sample support surface 206A and cover support surface 206R defining a similar cylindrical wall to the recess 204R therebetween. However, in other instances, outer perimeter and/or recess 204R of cover 204 may have any other suitable profile, such as a rectangular, square, pyramidal, and/or the like with base 206 having any suitable corresponding profile.

When cover 204 is assembled together with base 206, a test volume VOL1 (FIG. 5) is defined between cover 204 and base 206 for receiving test sample 202. Test volume VOL1 is at least partially defined by recess 204R. For instance, test volume VOL1 is generally defined between the sample support surface 206A of base 206 and interior recessed surface 204C along a sixth height H6 in vertical direction V1 and by sidewall of recess 204R along second distance D2 in lateral direction LT1. When sample support surface 206A is positioned above cover support surface 206R, sixth height H6 is less than second height H2.

Reaction gas(es) is supplied from interior volume 104 of reaction chamber 102 to test volume VOL1 through at least one metering inlet 208 defined by the test device 200. In one embodiment, metering inlet 208 is defined in cover 204. For instance, metering inlet 208 is defined through upper surface 204A of cover 204 and opens to test volume VOL1. In some instances, metering inlet 208 is substantially linear and extends parallel to and along vertical direction V1 such that metering inlet 208 extends across an overall length L1 from upper surface 204A to interior recessed surface 204C equal to third height H3. However, in some instances, metering inlet 208 may only partially extend parallel to and along vertical direction V1 or may extend across any suitable shaped path (e.g., spiral, zig-zag, curved, etc.) such that length L1 may be greater than third height H3. Moreover, metering inlet 208 may have a width W1 (e.g., diameter) in lateral direction LT1. In some instances, width W1 is substantially constant along length L1. However, in one or more instances, width W1 may vary along length L1. For instance, in one instance, width W1 may taper (e.g., narrow or widen) along length L1 from upper surface 204A towards interior recessed surface 204C.

It should be appreciated that overall length L1 of metering inlet 208, width W1 of metering inlet 208, and/or third height H3 of cover 204 may be selected such that at least one dimension of metering inlet 208 corresponds to a dimension of a crack in a part to be cleaned using the reaction chamber 102, outside of the test device 200. For instance, a part to be cleaned (e.g., one of component(s) 118) may have a wall thickness that may define a crack (e.g., crack(s) C1, C2, C3 in FIGS. 1 and 2) extending at least partially or completely therethrough. Overall length L1 of the metering inlet 208 may be configured to correspond to the wall thickness at the location of the crack of a respective part to be cleaned, in the case of a crack that extends completely therethrough, or the approximate length of the crack (e.g., half the wall thickness at the crack) if not extending completely through the wall. For instance, overall length L1 of the metering inlet 208 may be configured to be substantially equal to the wall thickness at the location of the crack of a respective part to be cleaned when the crack in the used part being cleaned extends completely through the wall. Similarly, width W1 of metering inlet 208 may correspond (e.g., be substantially equal to) a width of the crack in the respective part to be cleaned. In some instances, width W1 may correspond to a width of the crack in the respective part at a surface of the respective crack. In some instances, if a width of a crack in a respective part tapers from an outer surface towards an inner surface, width W1 of metering inlet 208 may taper in a similar way, with the same or similar change in dimensions. As such, reaction gases must traverse a similar path through the metering inlet 208 as through the crack(s) in the respective part to be cleaned.

It should be appreciated that, while metering inlet 208 is shown as being defined through the upper cover surface 204A of cover 204, metering inlet 208 may be defined in any other suitable location of cover 204, such as sidewall 204S, and/or base 206. Moreover, it should be appreciated that, while only one metering inlet 208 is shown, multiple metering inlets 208 may instead be defined in test device 200. For instance, if a part to be cleaned has multiple cracks, a similar (e.g., same) number of metering inlets 208 may be provided to simulate changes in gas flow due to the multiple cracks and any resulting change in cleaning efficacy. In some instances, each of multiple metering inlets 208 in a given test device 200 may be sized according to respective cracks such that each metering inlet 208 may have a different dimension. However, in one or more instances, each of multiple metering inlets 208 in a given test device 200 is configured substantially the same.

In some instances, a particular ratio of an empty portion of test volume VOL1 to a sample volume of test volume VOL1 taken up by sample 202 may be desired. Generally, more dead or empty space within test volume VOL1 around test sample 202 leads to slower FIC processing within test volume VOL1. In one instance, for example, second height H2 is selected to be approximately equal to double or twice third height H3, while fourth height H4 is selected to be approximately equal to third height H3, and similarly, sample height H7 of test sample 202 may be selected to be approximately equal to third height H3. In such instances, when assembled, there is very little space between test sample 202 and interior recessed surface 204C in vertical direction V1.

Moreover, in some instances, a particular ratio of sample surface area to test volume VOL1 may be desirable. In such instances, shape of sample 202 and/or shape of recess 204R may be adjusted to reach such desired ratio of sample surface area to test volume VOL1. For instance, to increase the ratio of sample surface area to test volume VOL1, sample 202 may have a textured exterior 202T (e.g., helical, threaded, ribbed, etc.), may be a scrolled material (e.g., rolled up sheet metal) that allows gas to go between layers of the material, and/or the like to increase surface area of sample 202. The surface area to volume ratio may be selected such that a mass-loss of the test sample 202 caused by the FIC process is measurable. It should be appreciated that, while not illustrated, in some instances, more than one sample 202 is received within the test volume VOL1 to increase the surface area being cleaned.

In particular instances, cover 204 is configured to be detachably couplable to base 206 for ease of removal of test sample 202 from test volume VOL1 after FIC processing. Cover 204 and base 206 may be made of materials such as metals, metal alloys, and/or the like that are generally low in materials that are being cleaned. In other words, cover 204 and base 206 should be made of materials that are not, or are not substantially, reduced by the FIC process. For instance, if a part to be cleaned (e.g., component(s) 118) and test sample 202 are primarily made of aluminum, cover 204 and base 206 should have low or no quantities of aluminum, such as a high nickel, low aluminum alloy. As reactive component(s) of the FIC stream are not consumed by cover 204 or base 206, direct comparisons between various test results can be made as the experimental conditions (i.e., reactant composition reaching test sample 202) would be identical for each test.

When cover 204 and base 206 are primarily made of metal, cover 204 and/or base 206 may be prepared before coupling to prevent permanent coupling (e.g., welding) of cover 204 and base 206 together during FIC processing. For example, in some instances, a ceramic ring CR1 may be positioned between cover 204 and base 206, such as laterally between sample support surface 206A and sidewall of recess 204R, vertically between lower cover surface 204B and cover support surface 206R, and/or the like, where each ceramic ring CR1 is made of a ceramic material that does not weld to the material(s) of cover 204 or of base 206 during FIC processing. Additionally, or alternatively, in some instances, brazing stop-off paste PA1 may be applied to cover 204 and/or base 206, such as vertically between lower cover surface 204B and cover support surface 206R, laterally between sample support surface 206A and sidewall of recess 204R, and/or the like, where the brazing stop-off paste PA1 is made of a mixture of metallic-oxide powders (e.g., aluminum-oxide, titanium oxide, yttrium-oxide, magnesium-oxide, etc.) and a liquid carrier solution that prevents the material(s) of cover 204 and of base 206 from welding to each other during FIC processing. It should be appreciated that brazing stop-off paste PA1 may affect the efficacy of the FIC process if brazing stop-off paste PA1 is on test sample 202. As such, it is particularly advantageous for cover support surface 206R to be positioned lower than sample support surface 206A, such as within the recess partially defined by cover support surface 206R, to reduce the likelihood of brazing stop-off paste PA1 from contacting test sample 202.

It should be appreciated that any other suitable material(s), such as commercially available high temperature glues and/or high temperature greases, may be positioned between cover 204 and base 206 to prevent permanent coupling of cover 204 and base 206 during FIC processing, as well as to provide sealing so that reactant gas can only enter into test volume VOL1 through metering inlet 208 during FIC processing. Such high temperature glues and/or greases include, but are not limited to, Loctite 2000F Putty by Imperial; VS-K 1500, VS-K 1300, and/or VS-K 1200 by GTeek; Alumina-and/or Aluminum Nitride (AlN-) containing Ceramabond products; and/or Resbond Adhesives. Oxide (e.g., oxide ceramics), for example, may be applied either at the location of brazing stop-off paste PA1 or the location of ceramic ring CR1 in FIG. 5, where oxides above alumina on the Ellingham plot (e.g., titania, silica, chromia, and/or the like) serve as sacrificial material to prevent reactant gases from entering test volume VOL1, while oxides below alumina on the Ellingham plot (e.g., yttrium oxide, magnesium oxide, and/or the like) act as inert seals to achieve the same purpose in preventing reactant gases from entering test volume VOL1. For the former group of ceramic materials, lateral width D4 is at least the diameter or the thickness of test sample 202 to avoid complete consumption of the ceramic material at the location of brazing stop-off paste PA1 before the FIC processing is complete.

The test device 200 may have several features that help seal gaps between cover 204 and base 206 to better isolate the efficacy of cleaning the test sample 202 with reaction gases received through the metering inlet 208. For instance, when sample support surface 206A is positioned above cover support surface 206R in vertical direction V1, reaction gases must additionally turn from flowing between lower cover surface 204B and cover support surface 206R to flowing between sidewall of recess 204R and vertical sidewall of base 206 defined between sample support surface 206A and cover support surface 206R to reach interior volume VOL1, where such a turn slows down flow of reaction gases and reduces the likelihood of reaction gases from entering interior volume VOL1 from between cover 204 and base 206. Similarly, when cover support surface 206R is part of a recess, reaction gases must additionally turn from flowing between sidewall 204S of cover 204 and vertical sidewall of base 206 defined between top surface 206T and cover support surface 206R to flowing between lower cover surface 204B and cover support surface 206R, where such turn similarly slows down flow of reaction gases and reduces the likelihood of reaction gases from entering interior volume VOL1 from between cover 204 and base 206. Moreover, when ceramic ring(s) CR1 and/or brazing stop-off paste PA1 are used, gaps between cover 204 and base 206 are reduced or eliminated, which further helps prevent reaction gases from entering interior volume VOL1 from between cover 204 and base 206.

In some instances, cover 204 and base 206 may be configured to have a threaded connection for selectively coupling cover 204 and base 206 together. For instance, corresponding threads may be defined on sidewall of recess 204R and vertical sidewall of base 206 defined between top surface 206T and cover support surface 206R, and/or the like. Threaded connection(s) make the path for reaction gas flow between cover 204 and base 206 more tortuous, which reduces the likelihood of gases from entering interior volume VOL1 from between cover 204 and base 206. Varying the number of coupled threads may vary the degree of sealing between cover 204 and base 206.

In one or more embodiments, a sealing ring (not shown), such as a graphite sealing ring, may be received between the sidewall 204S of cover 204 and vertical sidewall of base 206 defined between top surface 206T and cover support surface 206R, along at least a portion of the perimeter of sidewall 204S, to further prevent reaction gases from entering interior volume VOL1 from between cover 204 and base 206. In some instances, sealing ring may extend around an entire perimeter of sidewall 204S.

Additionally, in some instances, test sample 202 has more than one layer of material, such as an exterior or sacrificial layer and an interior layer. For instance, test sample 202 may be titanium nickel coated carbide, where the titanium nickel is a different color from the carbide, and where the titanium nickel coated carbide is configured to wear off as the FIC process occurs. As such, it is easier to detect the efficacy of the cleaning process from a glance based on where and how much the titanium nickel coating has worn off. It should be appreciated that any other suitable combination of materials with similar differences in physical appearance may instead be used.

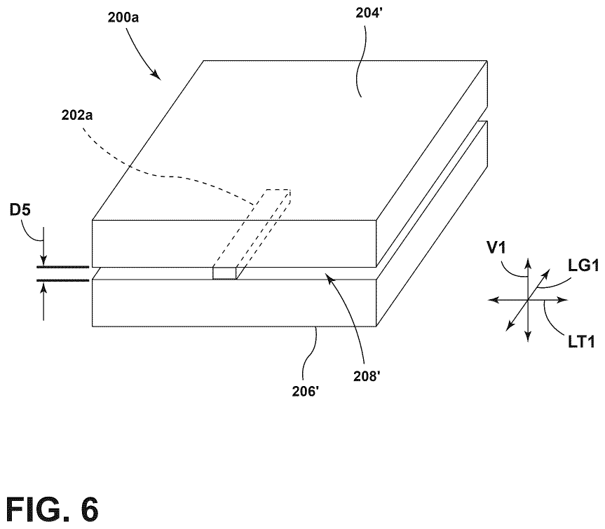

Turning now to FIG. 6, a perspective view of another configuration of a test device 200a suitable for use with the fluoride ion cleaning systems 100 shown in FIGS. 1 and 2 is illustrated in accordance with aspects of the present subject matter. As particularly illustrated, test device 200a similarly includes a cover 204′ and a base 206'. Each of cover 204′ and base 206′ is formed by a stress-relieved planar plate such that the heat cycling during the FIC process does not affect the shape of (e.g., deform) cover 204′ and base 206′. Cover 204′ is configured to rest (directly or indirectly) on base 206′ such that test sample 202a is received within a test volume defined therebetween. A metering inlet 208′ is defined between cover 204′ and base 206′. The metering inlet 208′ may extend around a substantial portion or all of the perimeter of test device 200a. Metering inlet 208′ extends across a fifth distance D5 in vertical direction V1. In some instances, test sample 202a spaces apart cover 204′ from base 206′ by fifth distance D5. However, in some instances, cover 204′ and/or base 206′ may have features (e.g., protrusions) that separate cover 204′ from base 206′ by fifth distance D5. Alternatively, or additionally, a further part (e.g., ceramic strip or ring) may be between the cover 204′ and base 206', and only partially surround test sample 202a, where such further part separates cover 204′ from base 206′ by fifth distance D5. In some instances, one or both of cover 204′ and base 206′ defines a recess configured to partially receive test sample 202a.

Fifth distance D5 preferably corresponds to a dimension of a crack in a part to be cleaned using the reaction chamber 102, outside of the test device 200a, similar to as described for metering inlet 208 in FIGS. 3-5. For instance, a part to be cleaned (e.g., one of component(s) 118) may have a wall thickness that may define a crack (e.g., crack(s) C1, C2, C3 in FIGS. 1 and 2) extending at least partially or completely therethrough. Fifth distance D5 of metering inlet 208′ may correspond (e.g., be substantially equal to) a width of the crack in the respective part to be cleaned. Fifth distance D5 may, in some instances, be substantially constant between cover 204′ and base 206′. However, in some instances, if a crack in a part being cleaned varies (e.g., tapers), fifth distance D5 may similarly vary (e.g., taper) from outer perimeter towards the center.

As reaction gases flow between cover 204′ and base 206′ through metering inlet 208′ into the test volume, test sample 202a is exposed to more gas proximate the perimeter of test device 200a at the metering inlet 208′ than towards the center of test device 200a. As such, test sample 202a may be better cleaned proximate metering inlet 208′ than further from metering inlet 208'. The efficacy of cleaning at a particular distance (e.g., in longitudinal direction LG1) from metering inlet 208′ that corresponds to (e.g., is equal to) the depth of the crack in a part to be cleaned indicates the estimated efficacy of the FIC processing at the crack of the part to be cleaned. For instance, the efficacy of cleaning at a distance equal to the wall thickness at the location of the crack in the case of a crack that extends completely therethrough, or the efficacy of cleaning at a distance equal to the approximate length of the crack if not extending completely through the wall, indicates the efficacy of the FIC processing at the crack of the part to be cleaned.

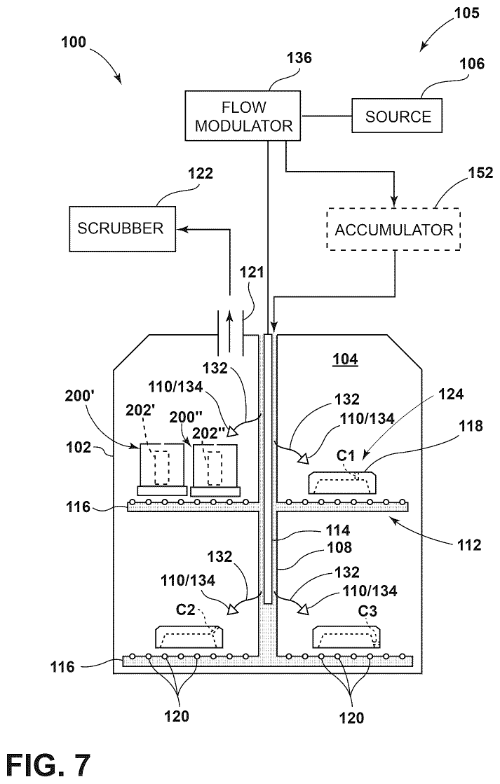

Referring now to FIG. 7, another example of a fluoride ion cleaning system is illustrated in accordance with aspects of the present subject matter. Particularly, the fluoride ion cleaning system has multiple test devices 200′, 200″ in reaction chamber 102. As described previously, one or more of components 118 may have one or more cracks (e.g., cracks C1, C2, C3) extending at least part of the way through a wall thickness of the component(s) 118. However, it may be difficult to determine the efficacy of the FIC process for cleaning the cracks. As such, in accordance with aspects of the present subject matter, at least one test device 200′, 200″ is provided for use within the FIC system 100. Each test device 200′, 200″ is configured to define a respective test volume for receiving one or more respective test samples 202′, 202″ to be cleaned with the FIC process. More particularly, test devices 200′, 200″ each define a respective metering inlet through which reaction gases may be passed from interior volume 104 of reaction chamber 102 (e.g., after exiting nozzles 110 and/or apertures 120) into the respective test volume, where the metering inlet is configured to act similar to a crack in a turbine component (e.g., crack C1, C2, C3 in respective components 118) configured to be cleaned, or simultaneously cleaned, with the FIC process. The metering inlet for each test device 200′, 200″ and corresponding test sample(s) 202′, 202″ may be selected to correspond to a particular turbine component to be cleaned. For instance, the metering inlet of test device 200′ and test sample 202′ may correspond to crack C1 in component 118, whereas metering inlet of test device 200″ and test sample 202″ may correspond to crack C2 in separate component 118. As such, the metering inlets of test devices 200′, 200″ may be different. In some instances, the metering inlets of test devices 200′, 200″ are the same and test samples 202′, 202″ are the same, such that multiple tests for simulating cleaning of a crack of a particular turbine component may be run simultaneously. Based on the cleaning of test samples 202′, 202″, the efficacy of the FIC process for cleaning the crack(s) in the respective turbine component(s) may be determined. Only two test devices have been shown, but it is to be understood that three or more test devices may be utilized within the same reaction chamber 102.

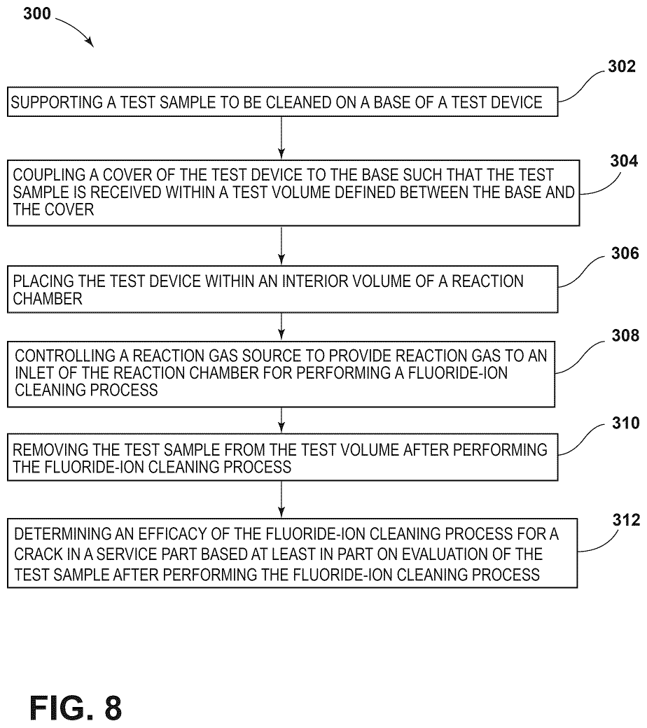

Referring now to FIG. 8 in particular, an exemplary method 300 according to embodiments of the present disclosure may be used for performing a fluoride-ion cleaning (FIC) process in accordance with aspects of the present subject matter. In general, method 300 is described herein with reference to FIC systems 100, 100′ described in FIGS. 1 and 2, test devices 200, 200′ described in FIGS. 3-6, and the example reaction gas flow and pressure pattern for FIC processes as described in FIGS. 7A-7B. However, it should be appreciated that method 300 may be implemented with any other suitable fluoride-ion cleaning system, any other suitable test device for use with fluoride-ion cleaning systems, and/or any other suitable reaction gas flow and pressure pattern for use with fluoride-ion cleaning systems. In addition, while FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, added, and/or adapted in various ways without deviating from the scope of the present disclosure.

At step (302), method 300 may include supporting a test sample to be cleaned on a base of a test device. For instance, as described above, test sample 202, 202′ may be configured to be made of a similar (or same) material as a part (e.g., part 118) to be cleaned. Test sample 202, 202′ may be oxidized similar to the part (e.g., part 118) to be cleaned or may be otherwise treated (e.g., surface treated) in preparation for FIC cleaning evaluation. Baselines of test sample 202, 202′ may be taken. For instance, test sample 202, 202′ may be weighed, imaged using microscopy, visually inspected (e.g., in case of coating), capacitance tested, and/or the like. Test sample 202, 202′ is then supported on base 206, 206′ of test device 200, 200′.

At step (304), method 300 may include coupling a cover of the test device to the base such that the test sample is received within a test volume defined between the base and the cover. For example, as discussed above, cover 204, 204′ may be supported on base 206, 206′ such that test sample 202, 202′ is received within a test volume VOL1 defined between base 206, 206′ and cover 204, 204′. In some instances, ceramic ring(s) CR1 and/or brazing stop-off paste PA1 is positioned between base 206, 206′ and cover 204, 204′ before coupling base 206, 206′ and cover 204, 204′.

At step (306), method 300 may include placing the test device within an interior volume of a reaction chamber. For instance, as discussed above, test device 200, 200′ with test sample 202, 202′ within test volume VOL1 may be placed within interior volume 104 of reaction chamber 102. In some instances, a part to be cleaned (e.g., part 118) having one or more cracks corresponding to the metering inlet(s) 208, 208′ of the test device 200, 200′ may also be placed in interior volume 104 of reaction chamber 102 along with test device 200, 200′ with test sample 202, 202′.

Further, at step (308), method 300 may include controlling a reaction gas source to provide reaction gas to an inlet of the reaction chamber for performing a fluoride-ion cleaning process. For example, as described above, reaction gas source (e.g., reaction gas source 106, flow modulator 136, and/or accumulator 152) may be controlled to provide reaction gas(es) to inlet of supply conduit 114 of reaction chamber 102 for performing the FIC process. The reaction gas source(s) may be controlled such that the FIC process may include cycling the reaction gas supply rate, pressures, and/or temperatures within at least a portion of the reaction chamber to vary the flow of the reaction gases and/or improve fluid (e.g., gas) exchange within cracks (e.g., cracks C1, C2, C3 in part(s) 118 and/or through metering inlet(s) 208, 208′ in test device(s) 200, 200′), which improves cleaning within such cracks.

Moreover, at step (310), method 300 may include removing the test sample from the test volume after performing the fluoride-ion cleaning process. For instance, after the FIC process is complete, test sample 202, 202′ may be removed from test volume VOL1. For example, cover 204, 204′ may be removed from being supported on base 206, 206′ such that test sample 202, 202′ may be removed from test device 200, 200′.

Additionally, at step (312), method 300 may include determining an efficacy of the fluoride-ion cleaning process for a crack in a service part based at least in part on evaluation of the test sample after performing the fluoride-ion cleaning process. For example, a weight of test sample 202, 202′ after performing the FIC process may be compared to the weight of test sample 202, 202′ from before performing the FIC process, where the change in weight of the test sample 202, 202′ is indicative of the cleaning efficacy of the FIC process for the test sample, 202, 202′, and in turn, is indicative of cleaning efficacy of the FIC process for the service part 118 simultaneously cleaned or to subsequently cleaned with the same FIC process settings. For instance, due to the test device 200, 200′ having the metering inlet 208, 208′ acting as a crack having dimensions corresponding to a crack C1, C2, C3 in service part 118, the change in weight of the test sample 202, 202′ indicates how well the crack C1, C2, C3 in service part 118 is cleaned. The larger the change in weight of the test sample 202, 202′, the better the cleaning of crack C1, C2, C3 in service part 118. In some instances, microscopy of test sample 202, 202′ after performing the FIC process is similarly compared to microscopy of test sample 202, 202′ from before the FIC process to determine the efficacy of the FIC process for test sample 202, 202′, which is indicative of the efficacy of the FIC process for crack C1, C2, C3 in service part 118. However, it should be appreciated that any other suitable method for evaluating the efficacy of the FIC process for cleaning the test sample 202, 202′, and thus, for determining the efficacy of the FIC process for a crack in a service part, may instead be used, such as comparing a capacitance or resistance in the part from before FIC processing to after the FIC processing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A system for fluoride-ion cleaning (FIC) processes, the system having a reaction chamber defining an interior volume, an inlet for providing reaction gas to the interior volume, and an outlet for exhausting the reaction gas from the interior volume. The system further has a reaction gas source coupled to the inlet, the reaction gas source configured to selectively provide the reaction gas to the inlet. Moreover, the system has at least one test device configured to be received within the interior volume of the reaction chamber, with a test volume being defined by each of the at least one test device. Each of the at least one test device defines a metering inlet through which the reaction gas from the interior volume of the reaction chamber is received in the test volume. Additionally, the system includes at least one test sample, each of the at least one test sample being configured to be received within the test volume of a respective one of the at least one test device and cleaned by the reaction gas received within the test volume through the metering inlet.

The system of one or more of these clauses, wherein at least one dimension of the metering inlet corresponds to at least one respective dimension of a crack in a service part to be cleaned within the reaction chamber.

The system of one or more of these clauses, wherein each of the at least one test device includes a base and a cover detachably couplable to the base, the cover having a sidewall extending between a first end and a second end, an upper surface at the first end, and a lower surface at the second end, the cover defining a recess extending from the lower surface towards the upper surface, the metering inlet extending through the cover to the recess, the test volume being at least partially defined by the recess.

The system of one or more of these clauses, wherein the base has a sample support surface and a cover support surface, the lower surface of the cover being configured to be supported on the cover support surface such that the sample support surface is positioned within the recess of the cover.

The system of one or more of these clauses, wherein the metering inlet extends through the upper surface to the recess.

The system of one or more of these clauses, wherein a thickness of the upper surface of the cover corresponds to a wall thickness of a service part to be cleaned, a length of the metering inlet being equal to the thickness of the upper surface.

The system of one or more of these clauses, wherein at least one of the recess or the at least one test sample is threaded.

The system of one or more of these clauses, further having at least one of a brazing stop-off paste or a ceramic barrier between the base and the cover.

The system of one or more of these clauses, wherein each of the at least one test device includes a base and a cover detachably couplable to the base, the cover and the base each being a stress relieved planar plate, the metering inlet being defined by a gap between the cover and the base.

Further aspects of the invention are provided by the subject matter of the following clauses:

A test device for a fluoride-ion cleaning (FIC) process. The test device is configured to be received within a reaction chamber for the FIC process. The test device includes a base, and a cover detachably couplable to the base to define a test volume between the cover and the base for receiving a test sample to be cleaned. The cover has a sidewall extending between a first end and a second end, an upper surface at the first end, and a lower surface at the second end. The cover defines a recess extending from the lower surface towards the upper surface. The cover further defines a metering inlet extending through the cover to the recess. The test volume is at least partially defined by the recess, with reaction gas being received in the test volume through the metering inlet from the reaction chamber. At least one dimension of the metering inlet corresponding to at least one respective dimension of a crack in a service part to be cleaned within the reaction chamber.

Additional aspects of the invention are provided by the subject matter of the following clauses:

A method for performing a fluoride-ion cleaning (FIC) process. The method includes supporting a test sample to be cleaned on a base of a test device. The method further includes coupling a cover of the test device to the base such that the test sample is received within a test volume defined between the base and the cover, with the test device defining a metering inlet through which reaction gas from a reaction chamber is receivable in the test volume. Further, the method includes placing, after coupling the cover of the test device to the base, the test device within an interior volume of the reaction chamber, with the reaction chamber defining an inlet for providing the reaction gas to the interior volume, and with the reaction chamber defining an outlet for exhausting the reaction gas from the interior volume. Moreover, the method includes controlling a reaction gas source to provide the reaction gas to the inlet of the reaction chamber for performing a FIC process. Furthermore, the method includes removing the test sample from the test volume after performing the FIC process. Additionally, the method includes determining an efficacy of the FIC process for cleaning a crack in a service part based at least in part on evaluation of the test sample after performing the FIC process.

The method of one or more of these clauses, wherein coupling the cover of the test device to the base includes detachably coupling the cover of the test device to the base with at least one of a brazing stop-off paste or a ceramic barrier between the cover and the base.

The method of one or more of these clauses, further including oxidizing the test sample before supporting the test sample on the base of the test device.

The method of one or more of these clauses, further including placing the service part having the crack within the reaction chamber before controlling the reaction gas source to provide the reaction gas.

The method of one or more of these clauses, wherein determining the efficacy of the FIC process based at least in part on the evaluation of the test sample after performing the FIC process includes comparing the test sample after performing the FIC process to the test sample before performing the FIC process.

The method of one or more of these clauses, wherein comparing the test sample after performing the FIC process to the test sample before performing the FIC process includes comparing at least one of: a weight of the test sample after performing the FIC process to a weight of the test sample before performing the FIC process; or microscopy images of the test sample after performing the FIC process to microscopy images of the test sample before performing the FIC process.

The method of one or more of these clauses, wherein coupling the cover of the test device to the base of the test device includes coupling the cover of the test device to the base of the test device, the cover having a sidewall extending between a first end and a second end, an upper surface at the first end, and a lower surface at the second end, the cover defining a recess extending from the lower surface towards the upper surface, the metering inlet extending through the upper surface to the recess, the test volume being at least partially defined by the recess.

The method of one or more of these clauses, wherein coupling the cover of the test device to the base of the test device further includes coupling the cover of the test device to the base of the test device, the base having a sample support surface and a cover support surface, the lower surface of the cover being configured to be supported on the cover support surface such that the sample support surface is positioned within the recess of the cover.

The method of one or more of these clauses, wherein coupling the cover of the test device to the base of the test device further includes coupling the cover of the test device to the base of the test device, a thickness of the upper surface of the cover corresponds to a wall thickness of the service part, a length of the metering inlet being equal to the thickness of the upper surface.

The method of one or more of these clauses, wherein coupling the cover of the test device to the base of the test device includes coupling the cover of the test device to the base of the test device, the cover and the base each being a stress relieved planar plate, the metering inlet being defined by a gap between the cover and the base.

What is claimed is:

1. A system for fluoride-ion cleaning (FIC) processes, the system comprising:
a reaction chamber defining an interior volume, an inlet for providing reaction gas to the interior volume, and an outlet for exhausting the reaction gas from the interior volume;
a reaction gas source coupled to the inlet, the reaction gas source configured to selectively provide the reaction gas to the inlet;
at least one test device configured to be received within the interior volume of the reaction chamber, a test volume being defined by each of the at least one test device, each of the at least one test device defining a metering inlet through which the reaction gas from the interior volume of the reaction chamber is received in the test volume; and
at least one test sample, each of the at least one test sample being configured to be received within the test volume of a respective one of the at least one test device and cleaned by the reaction gas received within the test volume through the metering inlet.

2. The system of claim 1, wherein at least one dimension of the metering inlet corresponds to at least one respective dimension of a crack in a service part to be cleaned within the reaction chamber.

3. The system of claim 1, wherein each of the at least one test device comprises a base and a cover detachably couplable to the base, the cover having a sidewall extending between a first end and a second end, an upper surface at the first end, and a lower surface at the second end, the cover defining a recess extending from the lower surface towards the upper surface, the metering inlet extending through the cover to the recess, the test volume being at least partially defined by the recess.

4. The system of claim 3, wherein the base comprises a sample support surface and a cover support surface, the lower surface of the cover being configured to be supported on the cover support surface such that the sample support surface is positioned within the recess of the cover.

5. The system of claim 3, wherein the metering inlet extends through the upper surface to the recess.

6. The system of claim 5, wherein a thickness of the upper surface of the cover corresponds to a wall thickness of a service part to be cleaned, a length of the metering inlet being equal to the thickness of the upper surface.

7. The system of claim 3, wherein at least one of the recess or the at least one test sample is threaded.

8. The system of claim 3, further comprising at least one of a brazing stop-off paste or a ceramic barrier between the base and the cover.

9. The system of claim 1, wherein each of the at least one test device comprises a base and a cover detachably couplable to the base, the cover and the base each comprising a stress relieved planar plate, the metering inlet being defined by a gap between the cover and the base.

10. A test device for a fluoride-ion cleaning (FIC) process, the test device being configured to be received within a reaction chamber for the FIC process, the test device comprising:
a base; and
a cover detachably couplable to the base to define a test volume between the cover and the base for receiving a test sample to be cleaned, the cover having a sidewall extending between a first end and a second end, an upper surface at the first end, and a lower surface at the second end, the cover defining a recess extending from the lower surface towards the upper surface, the cover defining a metering inlet extending through the cover to the recess, the test volume being at least partially defined by the recess, reaction gas being received in the test volume through the metering inlet from the reaction chamber, at least one dimension of the metering inlet corresponding to at least one respective dimension of a crack in a service part to be cleaned within the reaction chamber.

11. A method for performing a fluoride-ion cleaning (FIC) process, the method comprising:
supporting a test sample to be cleaned on a base of a test device;
coupling a cover of the test device to the base such that the test sample is received within a test volume defined between the base and the cover, the test device defining a metering inlet through which reaction gas from a reaction chamber is receivable in the test volume;
placing, after coupling the cover of the test device to the base, the test device within an interior volume of the reaction chamber, the reaction chamber defining an inlet for providing the reaction gas to the interior volume, the reaction chamber defining an outlet for exhausting the reaction gas from the interior volume;
controlling a reaction gas source to provide the reaction gas to the inlet of the reaction chamber for performing a FIC process;
removing the test sample from the test volume after performing the FIC process; and
determining an efficacy of the FIC process for cleaning a crack in a service part based at least in part on evaluation of the test sample after performing the FIC process.

12. The method of claim 11, wherein coupling the cover of the test device to the base comprises detachably coupling the cover of the test device to the base with at least one of a brazing stop-off paste or a ceramic barrier between the cover and the base.

13. The method of claim 11, further comprising oxidizing the test sample before supporting the test sample on the base of the test device.

14. The method of claim 11, further comprising:
placing the service part having the crack within the reaction chamber before controlling the reaction gas source to provide the reaction gas.

15. The method of claim 11, wherein determining the efficacy of the FIC process based at least in part on the evaluation of the test sample after performing the FIC process comprises comparing the test sample after performing the FIC process to the test sample before performing the FIC process.

16. The method of claim 15, wherein comparing the test sample after performing the FIC process to the test sample before performing the FIC process comprises comparing at least one of:
a weight of the test sample after performing the FIC process to a weight of the test sample before performing the FIC process; or
microscopy images of the test sample after performing the FIC process to microscopy images of the test sample before performing the FIC process.

17. The method of claim 11, wherein coupling the cover of the test device to the base of the test device comprises coupling the cover of the test device to the base of the test device, the cover having a sidewall extending between a first end and a second end, an upper surface at the first end, and a lower surface at the second end, the cover defining a recess extending from the lower surface towards the upper surface, the metering inlet extending through the upper surface to the recess, the test volume being at least partially defined by the recess.

18. The method of claim 17, wherein coupling the cover of the test device to the base of the test device further comprises coupling the cover of the test device to the base of the test device, the base comprising a sample support surface and a cover support surface, the lower surface of the cover being configured to be supported on the cover support surface such that the sample support surface is positioned within the recess of the cover.

19. The method of claim 17, wherein coupling the cover of the test device to the base of the test device further comprises coupling the cover of the test device to the base of the test device, a thickness of the upper surface of the cover corresponds to a wall thickness of the service part, a length of the metering inlet being equal to the thickness of the upper surface.

20. The method of claim 11, wherein coupling the cover of the test device to the base of the test device comprises coupling the cover of the test device to the base of the test device, the cover and the base each comprising a stress relieved planar plate, the metering inlet being defined by a gap between the cover and the base.
